(19) United States
(12) Patent Application Publication
(10) Pub. No.: US 2007/0180469 A1
(43) Pub. Date: Aug. 2, 2007

(54) Method of demographically profiling a user of a computer system

(76) Inventors: William Derek Finley, Ottawa (CA); Christopher William Doylend, Ottawa (CA); Gordon Freedman, Nepean (CA)

Correspondence Address: FREEDMAN & ASSOCIATES, 117 CENTREPOINTE DRIVE, SUITE 350, NEPEAN, ONTARIO, K2G 5X3, omitted

(21) Appl. No.: 11/698,897

(22) Filed: Jan. 29, 2007

Related U.S. Application Data
(60) Provisional application No. 60/762,514, filed on Jan. 27, 2006.

(51) Int. Cl. H04H 9/00; H04N 7/10; H04N 7/025; H04N 7/16; H04N 5/445; G06F 3/00; G06F 13/00

(52) U.S. Cl. 725/46; 725/13; 725/9; 725/34; 725/35

(57) ABSTRACT

A method of demographically profiling a user of a computer system includes providing an aggregated demographic bias associated with a plurality of different items, in dependence upon collected information relating to a plurality of demographically identified users. First information is then received from a demographically anonymous user, the first information being indicative of the demographically anonymous user's interest in each one of the plurality of different items. A demographic bias of the demographically anonymous user is estimated as a demographic bias that is statistically similar to the aggregated demographic bias associated with the plurality of different items.

This application claims the benefit of U.S. Provisional Application 60/762,514, filed on Jan. 27, 2006, the entire contents of which are incorporated herein by reference.

### FIELD OF THE INVENTION

The instant invention relates generally to data searching, and more particularly to a method of demographically profiling a user of a computer system.

### BACKGROUND

Data storage, analysis, retrieval and display have always been important aspects of computers. Although different data retrieval and data display models have been proposed over the years, most system designers return to one of three models due to their simplicity, ease of use, and user comprehensibility. These three models include the desktop model, the list based model, and the hierarchical list model.

The desktop model was popularized by Apple® with its Macintosh® computers, and is used to display computer operating system data in a virtual desktop environment. On a computer screen is shown an image of a two-dimensional desktop with files, folders, a trashcan, and so forth being represented by different icons that are arranged in some manner on the “surface” of the desktop. To access files that are stored on the computer system, a user simply selects an appropriate icon from the desktop display. Though the desktop model is convenient and intuitive, it is often difficult to implement due to system level constraints. For example, the Windows® operating system that is provided by Microsoft® Corporation has limitations on file name length and, as such, is sometimes unable to store files sufficiently deeply within nested folders to truly reflect the desktop based model. Further, since some systems are more limited than others, the model when implemented results in some limitations on portability. For many applications and for application execution, the desktop model is often poor.

Also, though the desktop model is well suited to providing user references for many different functions, it is poorly suited for organizing large volumes of data since it has no inherent organizational structure other than the one that is set by a user. Thus, similar to actual physical desktops, some virtual desktops are neat and organized while others are messy and disorganized. Thus, for data organization and retrieval, the virtual desktop model is often neutral—neither enhancing nor diminishing a user's organizational skills.

The list-based model is employed in all aspects of daily life. Music organization programs display music identifiers such as titles and artists in a list that is sortable and searchable based on many different criteria. Typically, sort criteria are displayed as column headers allowing for easy searching based on the column headers. Many applications support more varied search criteria and search definition.

Another example of list based data display is Internet search engines, which typically show a list of results for a provided search query. The results are then selectable for navigating to a World Wide Web Site relating to the listed result. Unfortunately, with the wide adoption of the World Wide Web and with significant attempts to get around search engine technology—to “fool” the search engines—it is often difficult to significantly reduce a search space given a particular query. For example, the search term “fingerprint” returns a significant number of results for biometric based fingerprinting similar to that used by police and a significant number of results for genetic fingerprinting using DNA. These results are distinct one from another.

The hierarchical list is similar to the list-based model but for each element within a higher-level list, there exist further sub-items at a lower level. Thus, a first set of folders allows for selection of a folder having within it a set of subfolders, etc. This allows for effective organization of listed data. In the above noted music list program example, classical music can be stored in a separate sub list from country music, etc.

Some complex data structures, such as for instance the organizational charts of large corporations, or of other similarly organized bodies such as for instance government or military units, consist of interconnected and highly correlated nodes. For instance, hierarchal organization charts of a large corporation may include a separate chart for each different unit of the corporation, with individuals and/or departments in each unit being represented as separate nodes in the chart, and with relationships between the separate nodes in the chart being shown as interconnections in two-dimensions. That said, it is often the case that relationships exist between individuals and/or departments in different units of the corporation, and accordingly the nodes of one chart actually are interconnected with the nodes of one or more of the other charts. Furthermore, it is often the case that different types of relationships exist between the nodes, such as for instance reporting relationships, communication relationships, financial relationships, etc. Unfortunately, current methods for analyzing and visualizing such highly correlated sets of data do not produce results that are intuitive to the user, and as a result the analysis is cumbersome and prone to errors and the visualization is confusing and prone to omissions.

Similar problems are associated generally with other types of highly correlated sets of data. For instance, in a computer system such as the Internet a plurality of users provide, on a daily basis, various types of information relating to their preferences, habits, demographic identity, etc. In fact, the number of users is extremely large in the case of the Internet, representing geographically diverse individuals over a broad range of demographic categories. Some attempts have been made to poll the users in order to obtain a pool of information that is useful in an e-commerce environment. However, typically such polling attempts are limited to individual sites, and the value of such information depends largely upon the accuracy and the honesty of the users.

It is also the case that, with every click of a mouse button, the users are providing some form of information about themselves. For instance, by selecting certain music compact disks (CDs) from a list, reading reviews for certain movies, providing opinions via certain web log (BLOG) sites, etc., that user is providing a wealth of information. As mentioned supra, current methods of analyzing and visualizing such highly correlated sets of data do not produce results that are intuitive to the user, and as a result the analysis is cumbersome and prone to errors and the visualization is confusing and prone to omissions.

It would be advantageous to provide a method for analyzing and/or visualizing highly correlated data sets that overcomes at least some of the above-mentioned limitations of the prior art.

### SUMMARY OF EMBODIMENTS OF THE INSTANT INVENTION

According to an aspect of the instant invention there is provided a method of demographically profiling a user of a computer system, comprising: providing an aggregated demographic bias associated with a plurality of different items in dependence upon collected information relating to a plurality of demographically identified users; receiving first information from a demographically anonymous user, the first information being indicative of the demographically anonymous user's interest in each one of the plurality of different items; and, estimating a demographic bias of the demographically anonymous user as a demographic bias that is statistically similar to the aggregated demographic bias associated with the plurality of different items.

According to an aspect of the instant invention there is provided a method of demographically profiling a user of a computer system, comprising: receiving first information from a first user, the first user being demographically anonymous and the first information being indicative of the first user's interest in each one of a plurality of different items; providing an aggregated demographic bias associated with the plurality of different items in dependence upon other information, the other information comprising template data relating to a plurality of demographically identified users; and, assigning the first user to a demographic group in dependence upon the determined aggregated demographic bias associated with the plurality of different items.

According to an aspect of the instant invention there is provided a computer-readable storage medium having stored thereon computer-executable instructions for performing a method of demographically profiling a user of a computer system, the method comprising: providing an aggregated demographic bias associated with a plurality of different items in dependence upon collected information relating to a plurality of demographically identified users; receiving first information from a demographically anonymous user, the first information being indicative of the demographically anonymous user's interest in each one of the plurality of different items; and, estimating a demographic bias of the demographically anonymous user as a demographic bias that is statistically similar to the aggregated demographic bias associated with the plurality of different items.

### BRIEF DESCRIPTION OF THE DRAWINGS

Exemplary embodiments of the invention will now be described in conjunction with the following drawings, in which similar reference numerals designate similar items:

FIG. 1 is a simplified flow diagram for a method of demographically profiling a user of a computer system according to an embodiment of the instant invention; and,

FIG. 2 is a simplified flow diagram for a method of demographically profiling a user of a computer system according to another embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and the scope of the invention. Thus, the present invention is not intended to be limited to the embodiments disclosed, but is to be accorded the widest scope consistent with the principles and features disclosed herein.

Methods according to the various embodiments of the instant invention are intended for use with computer systems, such as for instance the Internet of the World Wide Web. The Internet is a widely distributed computer system, including a vast network of computers and file servers that are located in virtually every country on the planet. Although the Internet started out being rather limited in its application, by virtue of relating mainly to highly specialized content of a technical nature and therefore being of interest mainly to the academic and scientific community, today its applications include on-line shopping, financial transactions, virtual diary spaces (web logs or BLOGS), and providing encyclopedic access to information that is of general interest to varied types of individuals and organizations. Furthermore, the continually increasing affordability of computer hardware coupled with improvements in access to high speed residential data transfer systems has resulted in a veritable explosion of use of the Internet over the last several years. The Internet currently enjoys much more widespread appeal, and as a result the individuals that are accessing the Internet now represent a much more demographically diverse group of people.

With wider acceptance and usage of the Internet, certain problems have developed that relate to the difficulty that is associated with selecting from an enormous amount of content only that content which is relevant to a specific individual at a specific time. While this problem is associated with content retrieval in general, such as for instance in reducing the search space that is returned by search engines in response to a query, similar difficulties also arise in other more specialized areas, such as for instance on-line electronic commerce. It is a well-known ploy for “bricks and mortar” based retailers to display products, especially near a point of transaction in a retail store. So, for instance, displays of highly desirable and personally satisfying merchandise (candy, magazines, etc.) are typically displayed near the checkout counter in a retail outlet. Furthermore, when the consumer is initially selecting an item for purchase in a retail outlet, other displays containing merchandise that is similar to or related to the selected item typically are conspicuous to the consumer. The theory, one must presume, is that it is far easier to tempt the consumer to spend more when they are already in a “buying mood.” While this tactic is certainly effective in terms of increasing sales revenue, nevertheless such displays are substantially static; at least over the period of time the consumer is shopping. Of course, by their very nature a display of physical items is rather unchanging over short periods of time, and accordingly they do not appeal to all consumers, all of the time.

Similar techniques have been applied in connection with e-commerce, that is to say, representations of other objects are presented for being viewed by a consumer during the on-line shopping experience. Often, the other objects are similar to or are related to items that have been placed in the “shopping cart” during a current session. However, these efforts are of questionable value since the consumer may, for instance, already own the other object, may have bought the object but returned it after purchase, may have read an opinion relating to that object and been put off by it, or may simply be purchasing a selected item in the shopping cart for another person, and actually have no real interest in other objects that are similar to the selected item. In this respect, the suggested items that are presented to a consumer prior to checkout will tend to have little more than a broad general appeal, and may or may not be of interest to that particular consumer.

It would be helpful to have access to personal information relating to the user, for the purpose of targeting the “checkout display” to provide the greatest temptation for that particular user to buy more as they are leaving the “store”. Unfortunately, some users are reluctant to provide any more than the absolute minimum amount of personal information that is required to complete the checkout process, and often this is done only grudgingly. Accordingly, polls and surveys either are not filled out by such users, or are filled out so as to be deceptively misleading. Furthermore, increasing threats relating to identity theft and on-line fraud have led some users to employ a third party facilitator, such as for instance PayPal™, to pay for their purchases. Attempts to provide targeted product displays and purchase suggestions for such very private users are bound to be unsuccessful.

That said, other users are much more free with their personal information and do not mind filling out surveys, polls and questionnaires, particularly in exchange for some form of compensation. In addition, focus groups and market testing campaigns in the real world also provide valuable information regarding the consumer habits and tendencies of different demographic groups. All such data relating to the consumer habits and tendencies at the demographic group level provide a valuable pool of communal information, without compromising private data of users, and which may be stored in a computer system for the purpose of getting to know more about the very private users.

According to an embodiment of the instant invention, a user provides data relating to their interest in each one of a plurality of items, which is done either intentionally and/or during the normal course of browsing and navigating between web pages. In this context, an item is categorizable as at least one of a consumer good, a service or an opinion. The user may indicate their interest in an item in terms of their willingness to pay for that particular item, in terms of an on-line rating they provide for that particular item, in terms of the number of times they return to “window shop” that particular item, etc. Such data, when it spans several different items, is considered to constitute the user's consumer history. Optionally, the user's consumer history is restricted to one particular shopping site, a group of inter-related shopping sites, or to the broader Internet in general.

In addition to storing the user's own consumer history, the computer system also stores highly correlated communal data relating to a plurality of demographically identified users. In particular, the communal data is arranged into a multi-dimensional data structure with interconnections established between a plurality of items, according to demographic group interest rather than individual interest in each item. Of course, some items are expected to have wide appeal spanning several demographic groups whilst other items are expected to appeal only to a few, or even one, demographic group.

By correlating a demographically anonymous user's interest in a plurality of items with template data, the template data in the form of the multi-dimensional data structure of the communal data, statistically it is possible to derive knowledge relating to a demographic profile of the demographically anonymous user. So for example the demographically anonymous user has associated therewith a consumer history indicating an interest in music CD#1, an interest in movie#1 and movie#4, and a lack of interest in book#2. By mapping data relating to the consumer history onto the multi-dimensional data structure of the communal data, it is determined that that particular combination of item interests has an aggregated demographic bias leaning toward demographic group A. In other words, based on communal data relating to a statistically significant number of other users, it is known that demographic group A has an interest in CD#1, an interest in movie#1, a lack of interest in movie#4, and a lack of interest in book#2, whilst another demographic group B has no information relating to CD#1, an interest in movie#1, lack of interest in movie#4, and interest in book#2. Analysis of the mapped data relating to the consumer history, according to a predetermined process, yields a result that is indicative of the demographically anonymous user's combination of an interest in music CD#1, an interest in movie#1 and movie#4, and a lack of interest in book#2 being demographically biased, in aggregate, toward demographic group A. Stated differently, the consumer history of the demographically anonymous user matches most closely with what is known about demographic group A. Based on this analysis, marketing strategies etc. that have been developed to target demographic group A specifically are applicable to the previously demographically anonymous user, with reasonable expectations of success. This may for instance take the form of displaying data relating to a plurality of other items having demographic biases associated therewith that are statistically similar to the aggregated demographic bias associated with the plurality of different items. Alternatively, a more expensive and more profitable item is suggested in place of a lower end model that is currently in the shopping cart, or bulk discounts are offered for purchases of multiple items. Alternatively, targeted advertising content is displayed, or special offers or contests are presented.

Improved results are expected over time as the demographically anonymous user's consumer history data is compiled and refined. When the consumer history expands to include a large number of items, determination of demographic particulars relating to that user generally becomes more statistically meaningful.

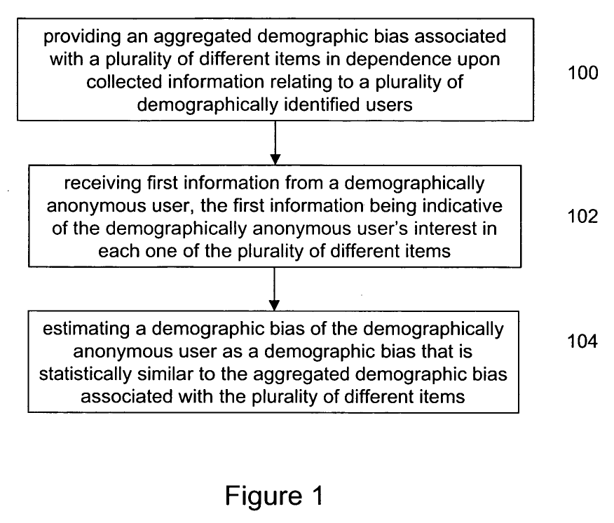

Referring to FIG. 1, shown is a simplified flow diagram for a method of demographically profiling a user of a computer system according to an embodiment of the instant invention. At step 100 an aggregated demographic bias associated with a plurality of different items is provided in dependence upon collected information relating to a plurality of demographically identified users. At step, 102 first information is received from a demographically anonymous user, the first information being indicative of the demographically anonymous user's interest in each one of the plurality of different items. At step 104 a demographic bias of the demographically anonymous user is estimated, as a demographic bias that is statistically similar to the aggregated demographic bias associated with the plurality of different items.

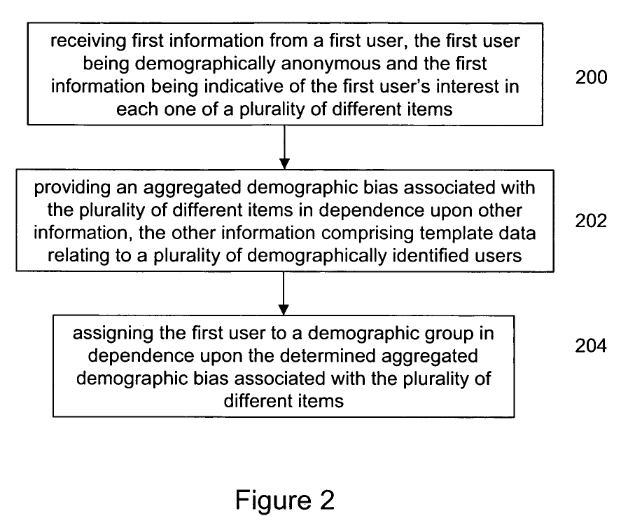

Referring now to FIG. 2, shown is a simplified flow diagram for a method of demographically profiling a user of a computer system according to an embodiment of the instant invention. At step 200, first information is received from a first user, the first user being demographically anonymous and the first information being indicative of the first user's interest in each one of a plurality of different items. At step 202 an aggregated demographic bias associated with the plurality of different items is provided in dependence upon other information, the other information comprising template data relating to a plurality of demographically identified users. At step 204 the first user is assigned to a demographic group in dependence upon the determined aggregated demographic bias associated with the plurality of different items.

Numerous other embodiments may be envisioned without departing from the spirit and scope of the invention.

What is claimed is:

1. A method of demographically profiling a user of a computer system, comprising:
providing an aggregated demographic bias associated with a plurality of different items in dependence upon collected information relating to a plurality of demographically identified users;
receiving first information from a demographically anonymous user, the first information being indicative of the demographically anonymous user's interest in each one of the plurality of different items; and,
estimating a demographic bias of the demographically anonymous user as a demographic bias that is statistically similar to the aggregated demographic bias associated with the plurality of different items.

2. A method according to claim 1 comprising displaying data relating to a plurality of other items each having associated therewith the estimated demographic bias.

3. A method according to claim 1 comprising displaying data relating to an advertisement based on the demographic group to which the first user is assigned.

4. A method according to claim 1 comprising determining the aggregated demographic bias associated with the plurality of different items in dependence upon collected information relating to a plurality of demographically identified users.

5. A method according to claim 4 comprising displaying data relating to an advertisement based on the demographic group to which the first user is assigned.

6. A method according to claim 4 wherein the aggregated demographic bias is stored within a multi-dimensional data structure.

7. A method according to claim 6 comprising displaying a three-dimensional data visualization structure of the multidimensional data structure.

8. A method according to claim 1 wherein estimating comprises correlating a first three-dimensional data structure based on the first information with template three-dimensional data structures based on the collected information.

9. A method according to claim 2, comprising receiving second information from the demographically anonymous user, the second information indicative of the demographically anonymous user's interest in at least some of the plurality of other items.

10. A method according to claim 9, comprising assigning the demographically anonymous user to a demographic group in dependence upon the estimated demographic bias.

11. A method of demographically profiling a user of a computer system, comprising:
receiving first information from a first user, the first user being demographically anonymous and the first information being indicative of the first user's interest in each one of a plurality of different items;
providing an aggregated demographic bias associated with the plurality of different items in dependence upon other information, the other information comprising template data relating to a plurality of demographically identified users; and,
assigning the first user to a demographic group in dependence upon the determined aggregated demographic bias associated with the plurality of different items.

12. A method according to claim 11 comprising displaying data relating to a plurality of other items that are correlated with the demographic group to which the first user is assigned.

13. A method according to claim 11 comprising displaying data relating to an advertisement based on the demographic group to which the first user is assigned.

14. A method according to claim 11 wherein the aggregated demographic bias is stored within a multi-dimensional data structure.

15. A method according to claim 14 comprising displaying a three-dimensional data visualization structure of the multidimensional data structure.

16. A method according to claim 11 wherein assigning comprises correlating a first three-dimensional data structure based on the first information with a template three-dimensional data structures based on the template data relating to the plurality of demographically identified users.

17. A computer-readable storage medium having stored thereon computer-executable instructions for performing a method of demographically profiling a user of a computer system, the method comprising:
providing an aggregated demographic bias associated with a plurality of different items in dependence upon collected information relating to a plurality of demographically identified users;
receiving first information from a demographically anonymous user, the first information being indicative of the demographically anonymous user's interest in each one of the plurality of different items; and,
estimating a demographic bias of the demographically anonymous user as a demographic bias that is statistically similar to the aggregated demographic bias associated with the plurality of different items.
